(19) United States
(12) Patent Application Publication
(10) Pub. No.: US 2005/0187756 A1
(43) Pub. Date: Aug. 25, 2005

(54) System and apparatus for handling presentation language messages

(75) Inventors: Alan George Harford Montgomery, Levenshulme (GB); Craig Michael Johnson, High Peak (GB); Peter Kenneth Henshaw, Macclesfield (GB); Martin Charles Alexander Baxter, Knutsford (GB); Jeremy Matias Brown, Lisburn (GB); Andrew Harry Jarvis, Macclesfield (GB); Roy Howarth, Stalybridge (GB)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/788,132

(22) Filed: Feb. 25, 2004

(51) Int. Cl. G06F 17/27; G10L 15/18; G06F 9/46; G06F 9/45; G06F 15/16

(52) U.S. Cl. 704/9; 704/257; 704/275; 719/313; 717/143; 717/142; 709/206

(57) ABSTRACT

A method, device, chip, computer program, and system that handle presentation language messages including dividing the message into simple and complex sections. The system includes a terminal and a base station. As such, presentation language messages can be viewed by simple presentation devices while allowing the simple presentation devices to forward the presentation language message without losing complex sections that may be viewable to more complex devices to which the message is forwarded from the simple presentation device.

### FIELD OF THE INVENTION

The present invention relates generally to the handling of presentation language messages, including multimedia items such as text, images, video clips, and sound clips. More particularly, the present invention relates to the handling of multimedia items via Multimedia Messaging Service (MMS).

### BACKGROUND OF THE INVENTION

Multimedia is generally understood as the synchronized presentation of audiovisual objects to a user. It is typical to multimedia-related information that it may contain elements of highly different nature, like text, still images, simple graphical elements, video and sound.

Computers and other multimedia processing devices, such as, cell phones, and Personal Data Assistants (PDA's) communicate to one another in various ways, such as, email and FTP transfers. An industry standard in which these messages may be organized to allow for communication between devices in a non-real-time way is Multimedia Messaging Service (MMS). Multimedia messages that contain text video clips, and/or sound clips are transferred and received using MMS which is also typically accompanied by a Synchronized Multimedia Integration Language (SMIL) attachment that contains the message timing and layout information to synchronize the multiple media items. MMS enabled devices may have an editor to display/compose MMS messages and a player to play MMS messages. Messages received by a MMS enabled device are generally loaded into an editor or player of some kind.

MMS is generally applicable for conveying such messages to and from the terminals of packet-switched cellular radio networks such as GPRS (General Packet Radio Service) and the packet-switched parts of UMTS (Universal Mobile Telecommunication System) in a store-and-forward manner much like the SMS (Short Messaging Service) text messages are conveyed in the second generation digital cellular networks, e.g. GSM (Global System for Mobile telecommunications).

One problem inherent to multimedia messaging is that the editor or player may impose limitations on the complexity of the MMS message that can be displayed and/or created. For example, a mobile device with restricted resolution will limit image complexity to a level suitable for display. Similarly, a multimedia player may have restrictions on the complexity of MMS messages that can be played. Therefore, a message received by a device beyond the capabilities of the editor may restrict the message from being displayed. Such MMS messages could occur either because the MMS message was created on a more capable device, or because the MMS message was created on a future device.

A second problem occurs when the user desires to forward a received message with the users own additional modifications to another device. The forwarding process involves editing the original message which may require editing an MMS message beyond the creation capabilities of the editor.

U.S. patent application Ser. No. 2003/01 72121 A1 entitled “Method, apparatus, and system for providing multimedia messages to incompatible terminals” describes a method for providing multimedia messages to incompatible terminals, but it fails to discuss how to edit the multimedia files in the terminals.

Thus, there is a need for an improved method, device, chip, computer program, and system that handle complex multimedia messages. Further, there is a need to divide multimedia messages into simple and complex sections. Even further, there is a need to edit content, forward, and receive multimedia messages with content that may be beyond the capabilities of a particular editor.

### SUMMARY OF THE INVENTION

The present invention is directed to a method, device, chip, computer program, and system that handle presentation language messages. The presentation language messages are divided into simple and complex sections. Simple sections include information that is within the display and/or editing capabilities of simple editors. Complex sections include information that is beyond the display and/or editing capabilities of simple editors. As such, presentation language messages can be displayed and/or edited by simple presentation devices while allowing the simple presentation devices to forward the presentation language message without losing complex presentation language sections.

Briefly, one exemplary embodiment relates to a method for handling presentation language messages. The method includes receiving a presentation language message at a device, parsing the presentation language message into simple and complex sections, translating the parsed presentation language message for presentation to a user of the device, and providing the translated presentation language message to a presentation application of the device. If the presentation application can only present simple presentation language, only simple sections of the translated presentation language message are provided. The method further includes translating the presentation language message after presentation by the presentation application for communication of the presentation language message including any changes made by the user to a different device.

Another exemplary embodiment relates to a device that is configured for operation in a communication network with presentation language messaging. The device includes a communication interface that receives and transmits presentation language messages, an editor that enables a user to edit presentation language messages, and a processor coupled to the communication interface and the editor. The processor provides commands to parse received presentation language message into simple and complex sections; provides a translation of simple and/or complex sections of the parsed presentation language message to the editor, depending on capabilities of the editor; and provides the communication interface with translated presentation language messages including at least portions of the multimedia messages from the editor for communication to another device.

Yet another exemplary embodiment relates to a chip including programmed instructions for the handling of presentation language messages in a communication network. The chip includes instructions to parse received presentation language messages into simple and complex sections based on information included in an attachment to the presentation language messages; provide at least a portion of the parsed presentation language message to an editor, depending on capabilities of the editor; and prepare presentation language messages for outbound communication including in the presentation language messages any changes made to the presentation language messages using the editor.

Yet still another exemplary embodiment relates to a computer program that handles presentation language messaging by a device regardless of whether or not the device is capable of displaying, forwarding, or editing complex presentation languages. The computer program product includes a presentation application that presents a presentation language message at a device and computer code. The computer code parses the presentation language message into simple and complex sections; translates the parsed presentation language message to a format used by the presentation application for presentation; provides the translated presentation language message to the presentation application where if the presentation application can only present simple presentation languages, only simple sections of the translated presentation language message are provided; and translates the presentation language message from the presentation application including any changes made with the presentation application.

Another exemplary embodiment relates to a system that handles complex presentation language messages for both simple and complex capable devices. The system includes a base station communicatively connected to a network and capable of communicating presentation language messages and a terminal that communicates with the base station, including a presentation language message. The terminal includes a presentation application that presents at least portions of the presentation language message according to capabilities of the presentation application. The terminal separates the presentation language message into simple and complex sections and communicates the presentation language message received from the base station including simple and complex sections, including any new or modified sections formed using the presentation application, regardless of whether or not the presentation application is capable of presenting the complex sections of the presentation language messages.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a diagrammatic representation of a communication system in accordance with an exemplary embodiment.

FIG. 2 is a diagrammatic representation of the flow of data in the system of FIG. 1 when a received message is forwarded, the user modifies some of the original simple section, inserts a further simple section, and sends a resulting message in accordance with an exemplary embodiment.

FIG. 3 is a flow diagram depicting operations in a communication system with complex multimedia message handling in accordance with an exemplary embodiment.

FIG. 4 is diagrammatic representation of a device in the system of FIG. 1 in accordance with an exemplary embodiment.

### DETAILED DESCRIPTION OF EXEMPLARY EMBODIMENTS

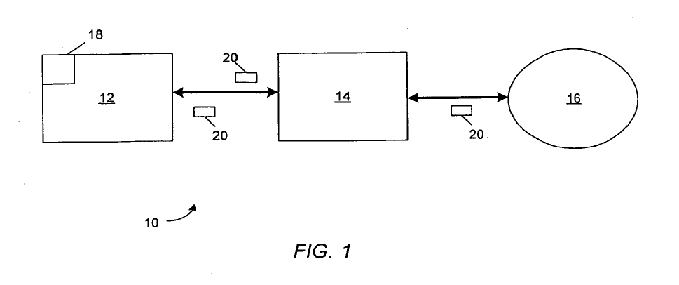

FIG. 1 illustrates a communication system 10 having a terminal 12, a base station 14, and a network 16. The terminal 12 can be any of a variety of different communication devices, such as a personal digital assistant (PDA), a phone, a computer, or a computing device integrated into another apparatus. The base station 14 can be a station located proximate the terminal 12 that provides communication of messages to and from the terminal 12. The messages communicated to and from the terminal 12 can be communicated to and from the network 16.

The terminal 12 has an editor 18 that presents messages for display and editing. In an exemplary embodiment, the editor 18 is a simple editor with limited capabilities for presenting graphics, sound, and other multimedia features. Alternatively, the terminal 12 has a presentation application that presents (e.g., displays) the messages without a facility for editing them. Presentation language messages 20 are communicated to the terminal 12 from the base station 14. The base station 14 receives the presentation language messages from the network 16, which receives them from other simple and complex devices.

Presentation language messages 20 are considered to have a combination of simple and complex sections. Simple sections include presentation information that is within the display and/or editing capabilities of the editor 18. Complex sections include presentation information that is beyond the display and/or editing capabilities of the editor 18. According to an exemplary embodiment, in editing, simple and complex sections are presented using the available capabilities of the terminal 12. However, complex sections are clearly identifiable as such. Only the complex sections in the forwarded presentation language message are unchangeable by simple editors, all simple sections can be changed and new content can be added to the message at any point outside complex sections of the presentation language message. Although simple editors cannot change complex sections, they can still remove complex sections from the presentation language message. In an exemplary embodiment, the presentation language messages are multimedia messaging service (MMS) messages.

Unedited sections are copied from the original message for future transmission. As such, simple sections that are not edited preserve information that is not considered significant enough to make the section complex, but is not supported by the editor.

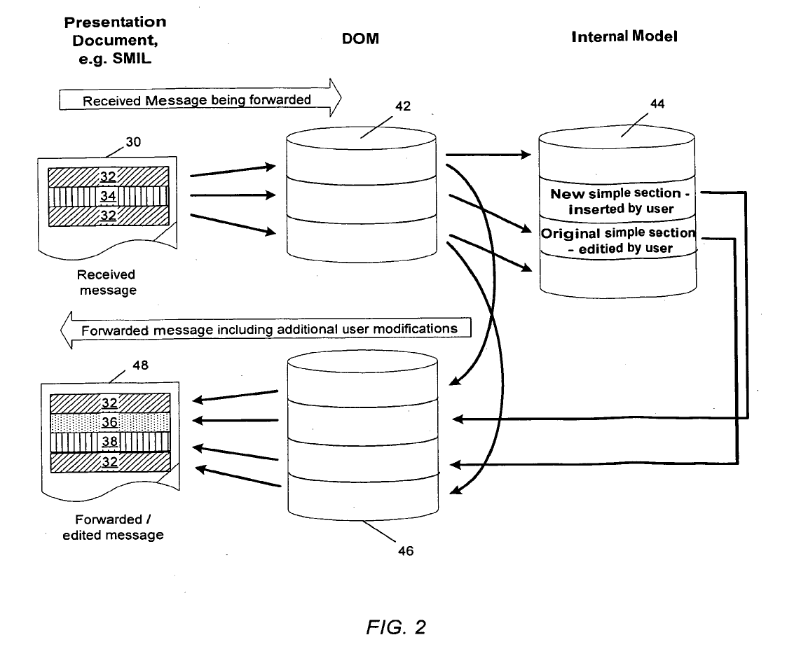

FIG. 2 illustrates a flow of data when a received message is forwarded, the user modifies some of the original simple section, inserts a further simple section, and sends a resulting message. According to an exemplary embodiment, when a presentation language message is loaded into an editor, the message is mapped into an internal representation so that it can be displayed to edit by a user on a section by section basis. This mapping from a time based presentation language message into a section oriented representation is driven by the contents of a presentation document that accompanies a presentation language message 30, such as a synchronized multimedia integration language (SMIL) presentation document. The presentation language message 30 can include complex sections 32 and a simple section 34.

The sections in presentation language message 30 are parsed into a Document Object Model (DOM) 42 and translated into an internal model 44 that represents what the editor actually presents to a user. During this translation, those parts of the DOM 42 that can be mapped to the display and/or editing capabilities of the editor are stored in the internal model 44 as simple sections. However, any parts of the DOM 42 that are beyond the capabilities of the editor are mapped to complex sections in the internal model 44.

The editor allows a user to edit the information in the internal model 44 except for complex sections. In an exemplary embodiment, although complex sections of the presentation language message 30 cannot be edited, they can still be removed from the message. When the editor saves the message, only those parts of the internal model 44 that have changed are written to a new DOM 46, with other sections in the new DOM 46 being copied from the original DOM 42. The DOM 46 is translated to generate the SMIL for the presentation language message. The forwarded message 48 can include complex sections 32, newly inserted simple section 36, and edited original simple section 38. If the presentation language message described by the SMIL presentation document is completely beyond the editor's understanding, then it is not possible to edit the presentation language message. As in the embodiment described with reference to FIG. 1, the presentation language message 30 can be a MMS message in some embodiments.

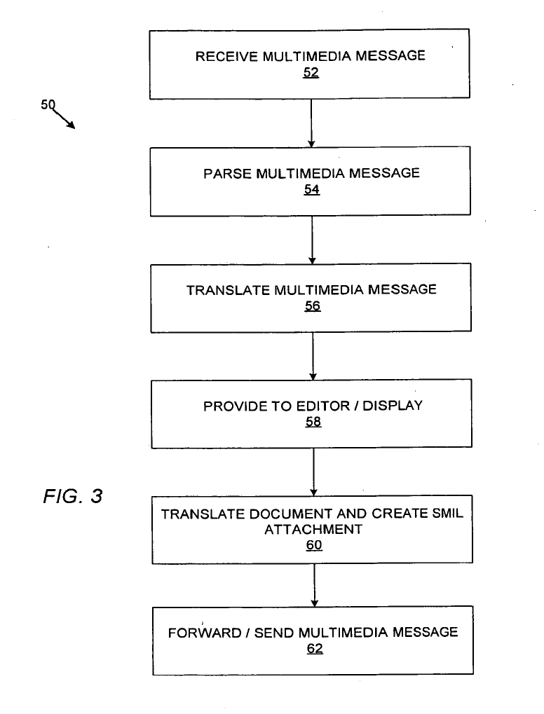

FIG. 3 illustrates a flow diagram 50 of exemplary operations in a communication system with multimedia message handling. Additional, fewer, or different operations may be performed in accordance with alternative embodiments. Moreover, some operations may be effectively performed in combination with an alternative operation.

In an exemplary embodiment, an operation 52 is performed in which a device receives a presentation language or a multimedia message. In an exemplary embodiment, the multimedia message can be a message having graphics, sound, text, and/or moving pictures. In an operation 54, the multimedia message is parsed into an object model where sections of the message are separated according to a SMIL attachment that contains message timing and layout information to synchronize the multiple media items in the message. The multimedia message is parsed into separate simple and complex sections. What constitutes a simple and a complex section is defined based on existing multimedia display and editor capabilities. Simple sections are able to be viewed and edited on simple editing and/or display devices. Complex sections are viewable and editable on more complex devices. The qualities of a simple and a complex section may change over time as the capabilities of viewers and/or editors change.

In an operation 56, the multimedia message is translated for presentation to the user. This translation takes the multimedia message from the object model to an internal model. In an alternative embodiment, the parsing operation of operation 54 and the translation operation of operation 56 are combined into one operation.

In an operation 58, the translated message is provided to the editor and/or display for presentation to the user. During presentation, the user may be able to edit the message. After editing the message, a use r can forward or send the multimedia message to another computing device. Before an outbound communication, an operation 60 is performed in which the message is translated. Part of the translation operation creates a SMIL attachment for the message. Where the editor can only support simple sections, the translation operation uses the simple sections from the editor and the complex sections originally received in the multimedia message but not used by the editor. As such, the totality of the multimedia message is maintained even though the editor cannot support the complex sections of the message. In an operation 62, the message is sent or forwarded to another device.

The exemplary embodiments described herein provide numerous advantages. For example, MMS messages beyond the capabilities of an editor can still be presented to users because the messages include both simple and complex parts. Also, if a forwarded MMS message contains content beyond the capabilities of editor, then only the complex sections in the MMS message are unchangeable while all simple sections can still be edited. Yet another advantage is that the complex sections in an MMS message can be removed from the message, if desired.

Another advantage is that as well as being able to add new content to the start and end of a forwarded MMS message, a simple editor can add new content anywhere outside the complex sections of a forwarded MMS message. Moreover, a wide range of devices, independent of device manufacturer, can utilize the multimedia messaging described herein to display, forward, and edit simple sections within SIMIL based MMS messages that also contain complex sections beyond the general functionality permitted by the editor. This messaging technique further allows removal of some complex sections and the insertion and/or editing of sections other than those at the beginning and/or end of the message.

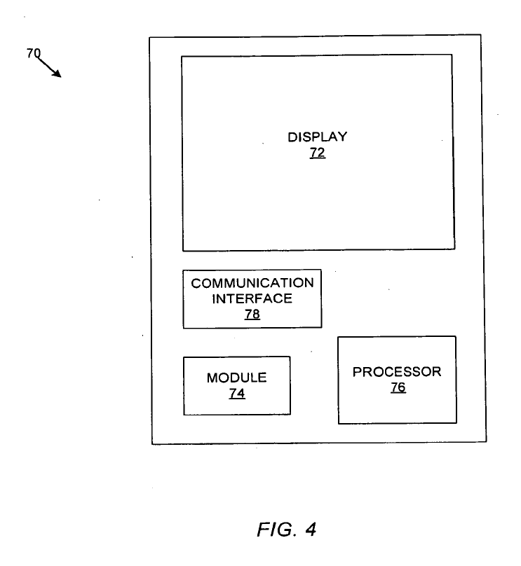

FIG. 4 illustrates a device 70 including a display 72, a module 74, a processor 76, and a communication interface 78. The display 72 can be a thin film transistor (TFT) display, a light emitting diode (LED) display, or any of a variety of different displays. The module 74 can be a computer chip or an arrangement of programmed instructions directing the handling of presentation language messages, such as complex multimedia messages or presentation language messages. The processor 76 executes instructions from the module 74 and instructions contained within the processor 76. The communication interface 78 provides an interface for receiving and transmitting messages.

The module 74 can include instructions to parse received multimedia messages into simple and complex sections based on information included in an attachment to the multimedia messages. The module can also provide at least a portion of the parsed multimedia message to an editor, depending on capabilities of the editor. Preferably, the editor is implemented by the processor 76 and presented on the display 72.

In an alternative embodiment, a computer program product is provided and executed by the processor 76. The computer program product handles presentation language messaging (such as multimedia messaging) regardless of whether or not the device is capable of displaying, forwarding, or editing the presentation language The computer program product can include a presentation application that presents a presentation language message at a device. The computer program product can also include computer code to parse the presentation language message into simple and complex sections and translate the parsed presentation language message to a format used by the presentation application for presentation.

This detailed description outlines exemplary embodiments of a method, device, chip, computer program, and system for handling presentation language messages. In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different presentation language messages and different combinations and uses of hardware and software for performing the same operations. The invention is not limited to a particular embodiment, but extends to various modifications, combinations, and permutations that nevertheless fall within the scope and spirit of the appended claims.

1. A method for handling presentation language messages, the method comprising:
receiving a presentation language message at a device;
parsing the presentation language message into simple and complex sections; and
translating the parsed presentation language message for presentation to a user of the device.

2. The method of claim 1, further comprising providing the translated presentation language message to a presentation application of the device, wherein if the presentation application can only present simple multimedia, only simple sections of the translated presentation language message are provided; and
translating the presentation language message after presentation by the presentation application for communication of the presentation language message including any changes made by the user to a different device.

3. The method of claim 2, wherein the presentation application of the device is a presentation language editor.

4. The method of claim 1, wherein parsing the presentation language message comprises parsing the presentation language message according to a synchronized multimedia integration language (SMIL) attachment to the presentation language message.

5. The method of claim 1, further comprising communicating the translated presentation language message including any changes made by the user, wherein the translated presentation language message includes an edited original simple section and a complex section.

6. The method of claim 5, wherein the translated presentation language message further includes a newly inserted simple section.

7. The method of claim 5, wherein the newly inserted simple section is located in between a complex section and a simple section in the translated presentation language message.

8. A computer program product that handles presentation language messaging by a device regardless of whether or not the device is capable of displaying, forwarding, or editing the presentation language, the computer program product comprising:
a presentation application that presents a presentation language message at a device; and
computer code to:
parse the presentation language message into simple and complex sections; and
translate the parsed presentation language message to a format used by the presentation application for presentation.

9. The computer program product of claim 8, wherein the code further:
provides the translated presentation language message to the presentation application, wherein if the presentation application can only present simple presentations, only simple sections of the translated presentation language message are provided; and
translates the presentation language message from the presentation application including any changes made with the presentation application.

10. The computer program product of claim 8, wherein the code that parses the presentation language message does so according to a synchronized multimedia integration language (SMIL) attachment to the presentation language message.

11. The computer program product of claim 8, wherein the presentation application comprises an editor.

12. The computer program product of claim 8, wherein the simple sections of the presentation language messages comprise portions of the presentation language messages that can be presented by a simple presentation application.

13. The computer program product of claim 8, wherein the computer cod e to translate the parsed presentation language message to a format used by the presentation application for presentation maps parts of the parsed presentation language message to the capabilities of the presentation application.

14. A system that handles presentation language messages for both simple and complex capable devices, the system comprising:
a base station communicatively connected to a network and capable of communicating presentation language messages; and
a terminal that communicates with the base station, wherein the communications include a presentation language message, wherein the terminal comprises a presentation application that presents at least portions of the presentation language message according to capabilities of the presentation application, wherein the terminal separates the presentation language message into simple and complex sections, wherein the terminal communicates the presentation language message received from the base station including simple and complex sections, including any new or modified sections formed using the presentation application, regardless of whether or not the presentation application is capable of presenting the complex sections of the presentation language messages.

15. The system of claim 14, wherein the terminal separates the presentation language message into simple and complex sections using a synchronized multimedia integration language (SMIL) attachment to the multimedia message.

16. The system of claim 14, further comprising a second terminal and a third terminal communicatively coupled to the base station, the second terminal being capable of presenting and editing simple and complex presentation language messages and the third terminal being capable of presenting and editing only simple presentation language messages, wherein the presentation language messages received by the third terminal and forwarded by the third terminal to the second terminal include complex sections.

17. The system of claim 16, wherein new sections are added to the presentation language message anywhere in the presentation language message by the second terminal and the third terminal.

18. The system of claim 17, wherein the second terminal adds complex sections to the presentation language message.

19. A device configured for operation in a communication network with presentation language messaging, the device comprising:
a communication interface that receives and transmits presentation language messages;
an editor that enables a user to edit presentation language messages; and
a processor coupled to the communication interface and the editor,
wherein the processor provides commands to parse received presentation language message into simple and complex sections; and to provide a translation, of simple and/or complex sections of the parsed presentation language message to the editor, depending on capabilities of the editor.

20. The device of claim 19, wherein the processor further provides the communication interface with translated presentation language messages including at least portions of the presentation language messages from the editor for communication to another device including any changes made to the presentation language messages using the editor.

21. The device of claim 19, wherein the processor parses the presentation language message into simple and complex sections using a synchronized multimedia integration language (SMIL) attachment to the multimedia message.

22. The device of claim 19, wherein the translation provided to the editor translates the presentation language message from an object model to an internal model.

23. The device of claim 19, wherein translated presentation language messages from the editor are only simple sections and the communication interface is provided with the simple sections from the editor and the complex sections received by the processor but not provided to the editor because of editor capabilities.

24. A chip including programmed instructions for the handling of presentation language messages in a communication network, the chip comprising:
instructions to parse received presentation language messages into simple and complex sections based on information included in an attachment to the presentation language messages; and to provide at least a portion of the parsed presentation language message to an editor, depending on capabilities of the editor.

25. The chip of claim 24, where the instructions further prepare presentation language messages for outbound communication including in the presentation language messages any changes made to the presentation language messages using the editor.

26. The chip of claim 24, wherein the attachment is a synchronized multimedia integration language (SMIL) attachment.

27. The chip of claim 24, wherein changes made to the presentation language messages using the editor include editing existing sections and adding new sections.

28. The chip of claim 27, wherein the existing sections and new sections are simple sections.
